(19) United States
(12) Patent Application Publication
(10) Pub. No.: US 2025/0336227 A1
(43) Pub. Date: Oct. 30, 2025

(54) DIFFERENTIAL HANDWRITING SKILL SCORE BASED MOTOR SKILL EVALUATION

(71) Applicant: International Business Machines Corporation, Armonk, NY (US)

(72) Inventors: Raquel Norel, Bronx, NY (US); Carla Paola Agurto Rios, Ossining, NY (US); Michele Merler, New York City, NY (US); Guillermo Cecchi, New York, NY (US)

(73) Assignee: International Business Machines Corporation, Armonk, NY (US)

(21) Appl. No.: 18/647,841

(22) Filed: Apr. 26, 2024

(51) Int. Cl. G06V 30/418; G06F 40/40; G06V 30/42

(52) U.S. Cl. CPC G06V 30/418; G06F 40/40; G06V 30/42

(57) ABSTRACT

An embodiment analyzes, using a first image-to-text model, a handwritten image, the analyzing resulting in a first text output corresponding to the handwritten image. An embodiment analyzes, using a second image-to-text model with a higher performance level than the first image-to-text model, the handwritten image, the analyzing resulting in a second text output corresponding to the handwritten image. An embodiment generates, by analyzing a difference between the first text output and the second text output, a handwriting skill score.

### BACKGROUND

The present invention relates generally to motor skill evaluation. More particularly, the present invention relates to a method, system, and computer program for differential handwriting skill score based motor skill evaluation.

Certain neurological conditions, such as Amyotrophic Lateral Sclerosis (ALS) and Parkinson's Disease (PD), are known to significantly impact human motor functions. ALS, which involves the degeneration of motor neurons, can lead to a progressive loss of muscle control, severely impairing the ability to perform fine motor tasks, including handwriting. Similarly, PD affects motor skills due to the loss of dopamine-producing cells in the brain, resulting in tremors, stiffness, and bradykinesia (slowness of movement). These symptoms can make the act of writing both laborious and imprecise, often causing handwriting to become small and cramped, a condition known as micrographia. As these and other neurological conditions affecting motor skills progress, the resulting deterioration in handwriting quality both affects an individual's daily life and serves as a proxy measurement for a disease's overall impact on an individual's motor abilities.

### SUMMARY

The illustrative embodiments provide for differential handwriting skill score based motor skill evaluation. An embodiment includes first analyzing, using a first image-to-text model, a handwritten image, the first analyzing resulting in a first text output corresponding to the handwritten image. The embodiment includes second analyzing, using a second image-to-text model with a higher performance level than the first image-to-text model, the handwritten image, the second analyzing resulting in a second text output corresponding to the handwritten image. The embodiment includes generating, by analyzing a difference between the first text output and the second text output, a handwriting skill score. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for differential handwriting skill score based motor skill evaluation in accordance with an illustrative embodiment;

FIG. 3 depicts an example of differential handwriting skill score based motor skill evaluation in accordance with an illustrative embodiment;

FIG. 4 depicts another example of differential handwriting skill score based motor skill evaluation in accordance with an illustrative embodiment;

FIG. 5 depicts another example of differential handwriting skill score based motor skill evaluation in accordance with an illustrative embodiment;

FIG. 6 depicts another example of differential handwriting skill score based motor skill evaluation in accordance with an illustrative embodiment; and

FIG. 7 depicts a flowchart of an example process for differential handwriting skill score based motor skill evaluation in accordance with an illustrative embodiment.

### DETAILED DESCRIPTION

The illustrative embodiments recognize that currently, motor skill deterioration is typically assessed by self-reporting, or by a medical professional (e.g., an occupational therapist, physical therapist, physician, or nurse) subjectively evaluating a person's handwriting or other motor skill. However, a subjective evaluation is unlikely to be consistent across evaluations performed by different people, particularly over a span of time. A subjective evaluation also relies on knowledge of a previous state of a person's handwriting, for comparison against a current state. A subjective evaluation also relies on an evaluator's reading skill in the language being handwritten. For example, a therapist who only reads English is likely to have difficulty evaluating handwritten Chinese or Japanese characters, or Greek or Cyrillic letters. There is also a known self-bias issue. Thus, the illustrative embodiments recognize that there is an unmet need for an objective measurement of handwriting skill, that does not rely on subjective evaluation and is consistent over time.

The present disclosure addresses the deficiencies described above by providing a process (as well as a system, method, machine-readable medium, etc.) that analyzes, using a first image-to-text model, a handwritten image; analyzes, using a second image-to-text model with a higher performance level than the first image-to-text model, the handwritten image; and generates, by analyzing a difference between an output of the first model and an output of the second model, a handwriting skill score. Thus, the illustrative embodiments provide for differential handwriting skill score based motor skill evaluation.

An illustrative embodiment receives a handwritten image. A handwritten image, as used herein, refers to an image, including a drawing, handwritten text in any language, or a combination, produced by a human person using a writing implement. Note that a writing implement includes a portion of a person's body, such as a finger. If the handwritten image is in physical form (e.g., drawn with a pen or pencil, or another physical writing implement, on paper or another writing surface), an embodiment uses a presently available technique (e.g., by using a digital camera) to digitize the handwritten image. If the handwritten image was drawn using a writing implement (e.g., a stylus or finger) on a touch-sensitive device (e.g., the surface of a tablet device or mobile device), an embodiment uses a presently available technique (e.g., an application executing on the tablet or mobile device) to convert sensed input to a digitized handwritten image. If the handwritten image was drawn using a writing implement (e.g., a stylus or finger) on a touch-sensitive device, one embodiment also receives metadata of the handwritten image (e.g., pen pressure data, writing implement speed data, writing implement position data, the order in which segments are drawn, the direction, and the pattern of putting the pen down and lifting it, and the like) generated by an input application executing on the device. In another embodiment, the handwritten image is received in a digitized form.

In some embodiments, the handwritten image is received in response to a prompt. Some non-limiting examples of a prompt instruct a user to write a specified string of text (e.g., “Please write: ‘This is a handwriting sample’”), to write unspecified text (e.g., “Please write one or two lines of text below this line”), to draw an object (e.g., “Please draw an analog clock”), to draw a geometrical shape (e.g., a triangle or a cube), and the like.

An image-to-text model outputs a text from a given image. Some presently available image-to-text models perform image captioning, generating a textual description of an image. Some presently available image-to-text models perform optical character recognition (OCR), converting text present in an image to text. Most image-to-text models trained on handwritten samples perform similarly on a writing sample from a person with undeteriorated handwriting skill, as the models' training included this type of sample. However, an image-to-text model with a comparatively higher performance level is more tolerant of handwriting by people with a tremor or another hand motor skill degradation than an image-to-text model with a comparatively lower performance level. Thus, an embodiment analyzes a handwritten image, using a first image-to-text model, resulting in a first text output corresponding to the handwritten image. An embodiment also analyzes the handwritten image, using a second image-to-text model, resulting in a second text output corresponding to the handwritten image. Both image-to-text models are presently available, and the second image-to-text model has a higher performance level than the first image-to-text model, as measured by any presently available image-to-text model performance metric.

An embodiment generates a handwriting skill score by analyzing a difference between the first text output and the second text output. To analyze a difference between the first and second text outputs, an embodiment computes a result of a presently available metric measuring a difference between two text strings, and uses the result as the handwriting skill score. Some non-limiting examples of a presently available metric measuring a difference between two text strings include edit distance (the number of character insertions, deletions, and substitutions to turn one text string into another text string), character error rate (the percentage of characters that are incorrect in one string as compared to another string), and word error rate (the number of inserted words, deleted words, and incorrect words in one string as compared to another string, divided by the total number of words in the reference string. Another embodiment incorporates metadata of the handwritten image, if available, into the handwriting skill score. For example, if the metadata of the handwritten image indicates a writing speed below a predefined threshold, a series of comparatively small writing implement movements indicative of a tremor, or another condition, an embodiment might reduce the handwriting skill score according to a rule, a percentage, or an amount. Another embodiment does not incorporate metadata of the handwritten image, if available, into the handwriting skill score, but instead uses metadata of the handwritten image to generate a separate metadata-based handwriting skill score using a presently available technique.

Another embodiment does not use two different image-to-text models, but instead uses one image-to-text model and compares the model's resulting text to a known portion of text. In one embodiment, the portion of text is the text a user was instructed to handwrite in a prompt. In another embodiment, the portion of text is text recognized by a human analyzing the handwritten image. In another embodiment, the portion of text is a text description of an object a user was instructed to handwrite in a prompt.

An embodiment generates a skill trend by comparing the handwriting skill score to one or more previous handwriting skill scores of a particular user. A medical professional, or the user, can use the resulting skill trend to track progression of a user's disease over time, alert the user or a caregiver to a more rapid deterioration than expected, and alert another to perform another intervention if appropriate to the user.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

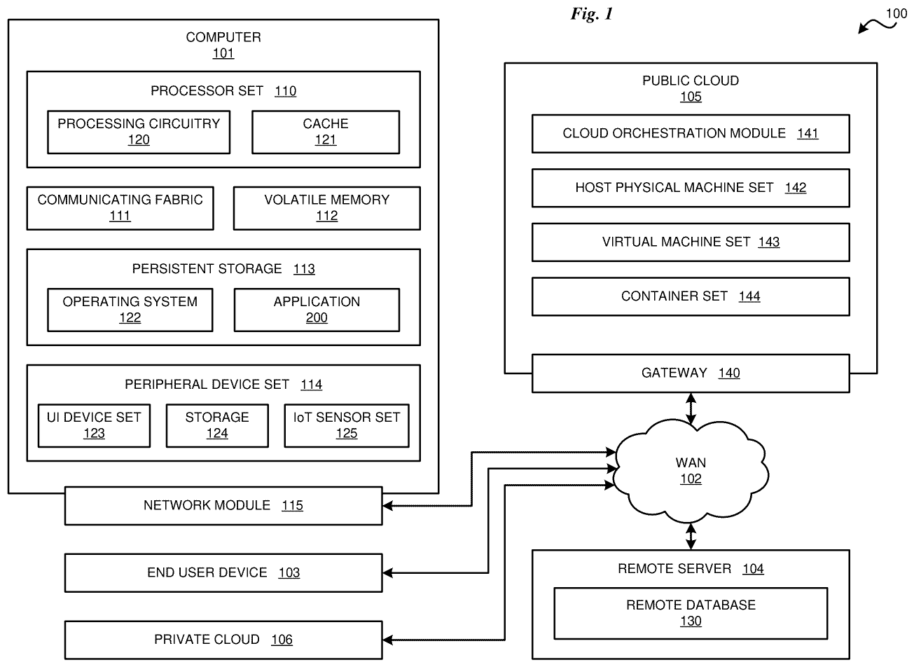

With reference to FIG. 1, this figure depicts a block diagram of a computing environment 100. Computing environment 100 contains an example of an environment for the execution of at least some of the computer code involved in performing the inventive methods, such as application 200 implementing differential handwriting skill score based motor skill evaluation. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

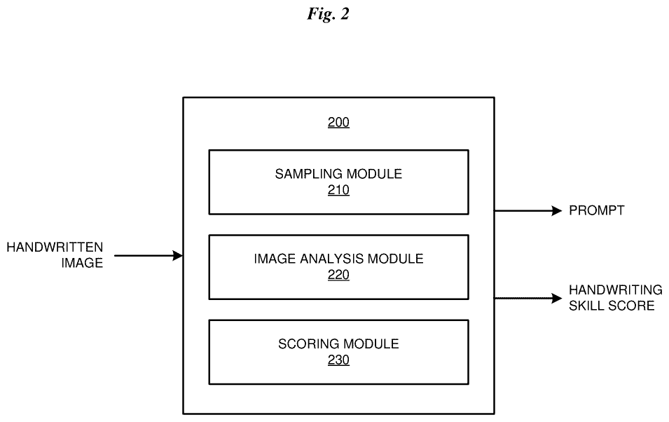

With reference to FIG. 2, this figure depicts a block diagram of an example configuration for differential handwriting skill score based motor skill evaluation in accordance with an illustrative embodiment. Application 200 is the same as application 200 in FIG. 1.

In the illustrated embodiment, sampling module 210 receives a handwritten image. If the handwritten image is in physical form (e.g., drawn with a pen or pencil, or another physical writing implement, on paper or another writing surface), module 210 uses a presently available technique (e.g., by using a digital camera) to digitize the handwritten image. If the handwritten image was drawn using a writing implement (e.g., a stylus or finger) on a touch-sensitive device (e.g., the surface of a tablet device or mobile device), module 210 uses a presently available technique (e.g., an application executing on the tablet or mobile device) to convert sensed input to a digitized handwritten image. If the handwritten image was drawn using a writing implement (e.g., a stylus or finger) on a touch-sensitive device, one implementation of module 210 also receives metadata of the handwritten image (e.g., pen pressure data, writing implement speed data, writing implement position data, the order in which segments are drawn, the direction, and the pattern of putting the pen down and lifting it, and the like) generated by an input application executing on the device. Another implementation of module 210 receives the handwritten image in a digitized form.

In some implementations of module 210, the handwritten image is received in response to a prompt. Some non-limiting examples of a prompt instruct a user to write a specified string of text (e.g., “Please write: ‘This is a handwriting sample’”), to write unspecified text (e.g., “Please write one or two lines of text below this line”), to draw an object (e.g., “Please draw an analog clock”), to draw a geometrical shape (e.g., a triangle or a cube), and the like.

Image analysis module 220 analyzes a handwritten image, using a first image-to-text model, resulting in a first text output corresponding to the handwritten image. Module 220 also analyzes the handwritten image, using a second image-to-text model, resulting in a second text output corresponding to the handwritten image. Both image-to-text models are presently available, and the second image-to-text model has a higher performance level than the first image-to-text model, as measured by any presently available image-to-text model performance metric.

Scoring module 230 generates a handwriting skill score by analyzing a difference between the first text output and the second text output. To analyze a difference between the first and second text outputs, module 230 computes a result of a presently available metric measuring a difference between two text strings, and uses the result as the handwriting skill score. Some non-limiting examples of a presently available metric measuring a difference between two text strings include edit distance (the number of character insertions, deletions, and substitutions to turn one text string into another text string), character error rate (the percentage of characters that are incorrect in one string as compared to another string), and word error rate (the number of inserted words, deleted words, and incorrect words in one string as compared to another string, divided by the total number of words in the reference string. Another implementation of module 230 incorporates metadata of the handwritten image, if available, into the handwriting skill score. For example, if the metadata of the handwritten image indicates a writing speed below a predefined threshold, a series of comparatively small writing implement movements indicative of a tremor, or another condition, module 230 might reduce the handwriting skill score according to a rule, a percentage, or an amount. Another implementation of module 230 does not incorporate metadata of the handwritten image, if available, into the handwriting skill score, but instead uses metadata of the handwritten image to generate a separate metadata-based handwriting skill score using a presently available technique.

Another implementation of module 230 does not use two different image-to-text models, but instead uses one image-to-text model and compares the model's resulting text to a known portion of text. In one implementation of module 230, the portion of text is the text a user was instructed to handwrite in a prompt. In another implementation of module 230, the portion of text is text recognized by a human analyzing the handwritten image. In another implementation of module 230, the portion of text is a text description of an object a user was instructed to handwrite in a prompt.

Module 230 generates a skill trend by comparing the handwriting skill score to one or more previous handwriting skill scores of a particular user. A medical professional, or the user, can use the resulting skill trend to track progression of a user's disease over time, alert the user or a caregiver to a more rapid deterioration than expected, and alert another to perform another intervention if appropriate to the user.

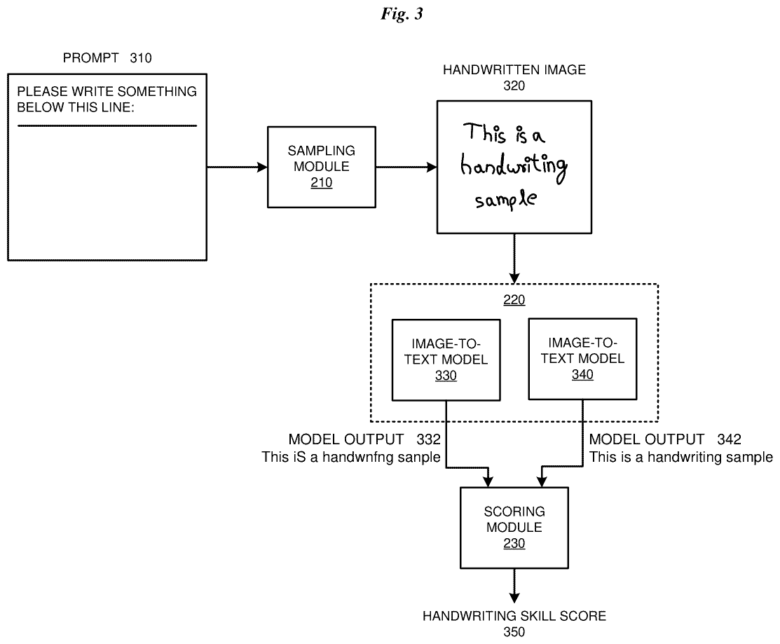

With reference to FIG. 3, this figure depicts an example of differential handwriting skill score based motor skill evaluation in accordance with an illustrative embodiment. Sampling module 210, image analysis module 220, and scoring module 230 are the same as sampling module 210, image analysis module 220, and scoring module 230 in FIG. 2. The example can be executed using application 200 in FIG. 2.

As depicted, in response to prompt 310, a user writes a portion of text, and sampling module 210 uses a presently available technique (e.g., by using a digital camera) to digitize the writing, generating handwritten image 320.

Image analysis module 220 analyzes handwritten image 320, using image-to-text model 330, resulting in model output 332. Module 220 also analyzes handwritten image 320, using image-to-text model 340, resulting in model output 342. Note that because image-to-text model 340 has a higher performance level than image-to-text model 330, there are more errors in model output 332 than there are in model output 342.

Scoring module 230 generates handwriting skill score 350 by analyzing a difference between model output 332 and model output 342.

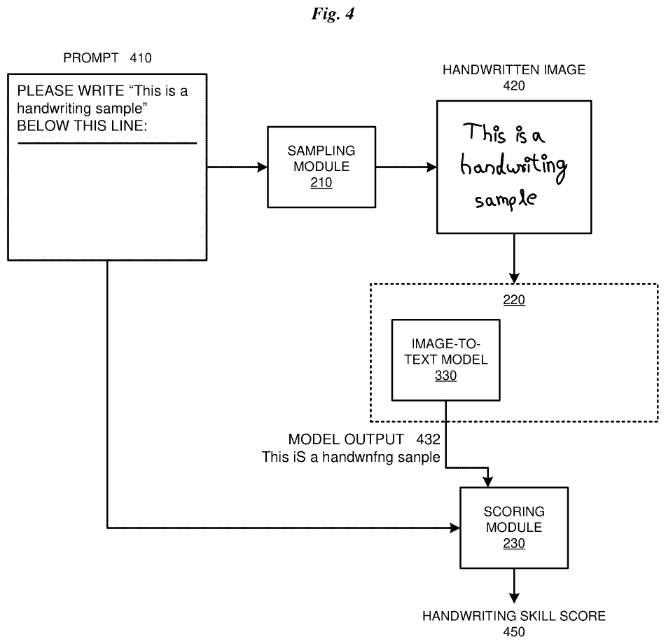

With reference to FIG. 4, this figure depicts another example of differential handwriting skill score based motor skill evaluation in accordance with an illustrative embodiment. Sampling module 210, image analysis module 220, and scoring module 230 are the same as sampling module 210, image analysis module 220, and scoring module 230 in FIG. 2. Image-to-text model 330 is the same as image-to-text model 330 in FIG. 3. The example can be executed using application 200 in FIG. 2.

As depicted, in response to prompt 410, a user writes the prescribed portion of text, and sampling module 210 uses a presently available technique (e.g., by using a digital camera) to digitize the writing, generating handwritten image 420.

Image analysis module 220 analyzes handwritten image 420, using image-to-text model 330, resulting in model output 432. Scoring module 230 generates handwriting skill score 450 by analyzing a difference between model output 432 and the known text in prompt 410.

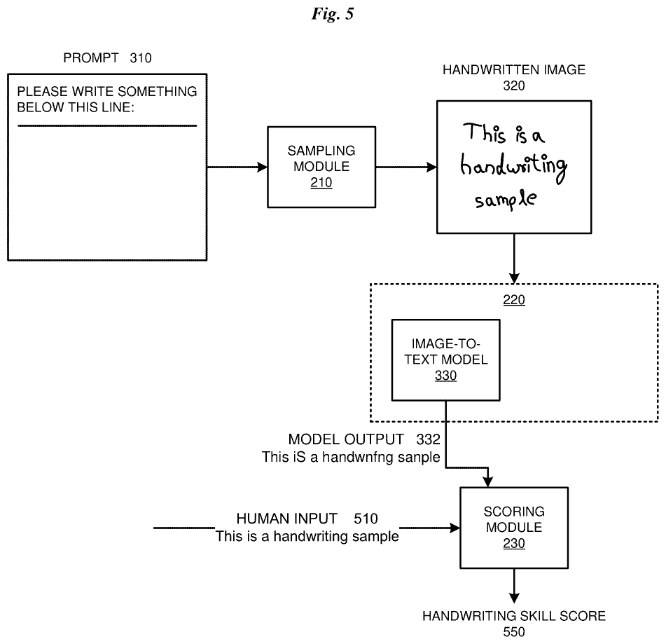

With reference to FIG. 5, this figure depicts another example of differential handwriting skill score based motor skill evaluation in accordance with an illustrative embodiment. Sampling module 210, image analysis module 220, and scoring module 230 are the same as sampling module 210, image analysis module 220, and scoring module 230 in FIG. 2. Prompt 310, handwritten image 320, image-to-text model 330, and model output 332 are the same as prompt 310, handwritten image 320, image-to-text model 330, and model output 332 in FIG. 3. The example can be executed using application 200 in FIG. 2.

As depicted, in response to prompt 310, a user writes a portion of text, and sampling module 210 uses a presently available technique (e.g., by using a digital camera) to digitize the writing, generating handwritten image 320.

Image analysis module 220 analyzes handwritten image 320, using image-to-text model 330, resulting in model output 332. Scoring module 230 generates handwriting skill score 550 by analyzing a difference between model output 332 and human input 510.

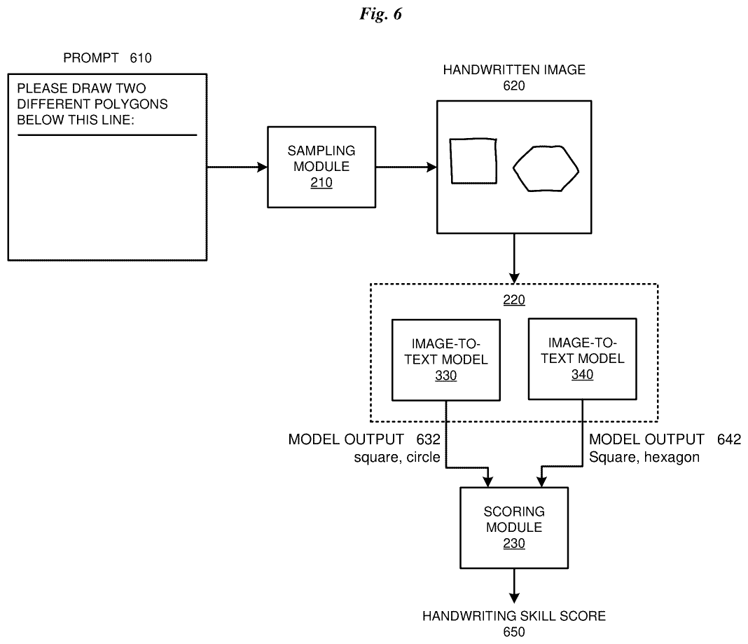

With reference to FIG. 6, this figure depicts another example of differential handwriting skill score based motor skill evaluation in accordance with an illustrative embodiment. Sampling module 210, image analysis module 220, and scoring module 230 are the same as sampling module 210, image analysis module 220, and scoring module 230 in FIG. 2. Image-to-text models 330 and 340 are the same as image-to-text models 330 and 340 in FIG. 3. The example can be executed using application 200 in FIG. 2.

As depicted, in response to prompt 610, a user draws a square and a hexagon, and sampling module 210 uses a presently available technique (e.g., by using a digital camera) to digitize the writing, generating handwritten image 620.

Image analysis module 220 analyzes handwritten image 620, using image-to-text model 330, resulting in model output 632. Module 220 also analyzes handwritten image 320, using image-to-text model 340, resulting in model output 642. Note that because image-to-text model 340 has a higher performance level than image-to-text model 330, there are more errors in model output 632 than there are in model output 642.

Scoring module 230 generates handwriting skill score 650 by analyzing a difference between model output 632 and model output 642.

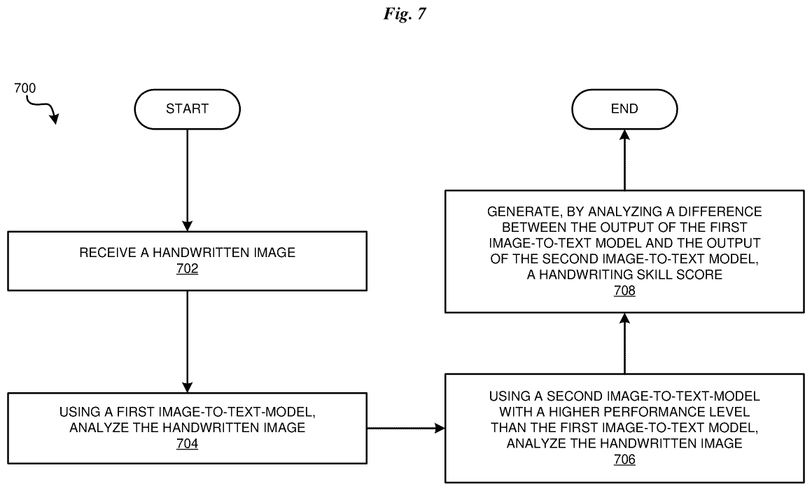

With reference to FIG. 7, this figure depicts a flowchart of an example process for differential handwriting skill score based motor skill evaluation in accordance with an illustrative embodiment. Process 700 can be implemented in application 200 in FIG. 2.

In the illustrated embodiment, at block 702, the process receives a handwritten image. At block 704, the process, using a first image-to-text model, analyzes the handwritten image. At block 706, the process, using a second image-to-text model with a higher performance level than the first image-to-text model, analyzes the handwritten image. At block 708, the process generates, by analyzing a difference between the output of the first image-to-text model and the output of the second image-to-text model, a handwriting skill score. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
first analyzing, using a first image-to-text model having a first performance level, a handwritten image, the first analyzing resulting in a first text output corresponding to the handwritten image;
second analyzing, using a second image-to-text model having a second performance level, the handwritten image, wherein the first performance level and the second performance level are configured using different tolerance levels for a handwriting variation, the second analyzing resulting in a second text output corresponding to the handwritten image; and
generating, by analyzing a difference between the first text output and the second text output, a handwriting skill score.

2. The computer-implemented method of claim 1, further comprising:
receiving a second handwritten image, the second handwritten image generated in response to a first prompt, the first prompt comprising a portion of text to handwrite;
third analyzing, using the first image-to-text model, the second handwritten image, the third analyzing resulting in a third text output corresponding to the second handwritten image; and
generating, by analyzing a difference between the third text output and the portion of text, a second handwriting skill score.

3. The computer-implemented method of claim 1, further comprising:
receiving a third handwritten image, the third handwritten image generated in response to a second prompt, the second prompt comprising an object to hand draw;
fourth analyzing resulting in a fourth text output corresponding to the third handwritten image; and
generating, by analyzing a difference between the fourth text output and the object, a third handwriting skill score.

4. The computer-implemented method of claim 3, wherein the object comprises a geometric shape.

5. The computer-implemented method of claim 1, further comprising:
generating, by analyzing a difference between the first text output and a fifth text output corresponding to the handwritten image, a handwriting skill score, wherein the fifth text output comprises an analysis of the handwritten image produced by a human.

6. The computer-implemented method of claim 1, further comprising:
generating, by comparing the handwriting skill score to a previous handwriting skill score, a skill trend.

7. A computer program product comprising one or more computer readable storage media, and program instructions collectively stored on the one or more computer readable storage media, the program instructions executable by a processor to cause the processor to perform operations comprising:
first analyzing, using a first image-to-text model having a first performance level, a handwritten image, the first analyzing resulting in a first text output corresponding to the handwritten image;
second analyzing, using a second image-to-text model having a second performance level, the handwritten image, wherein the first performance level and the second performance level are configured using different tolerance levels for a handwriting variation, the second analyzing resulting in a second text output corresponding to the handwritten image; and
generating, by analyzing a difference between the first text output and the second text output, a handwriting skill score.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
receiving a second handwritten image, the second handwritten image generated in response to a first prompt, the first prompt comprising a portion of text to handwrite;
third analyzing, using the first image-to-text model, the second handwritten image, the third analyzing resulting in a third text output corresponding to the second handwritten image; and
generating, by analyzing a difference between the third text output and the portion of text, a second handwriting skill score.

11. The computer program product of claim 7, further comprising:
receiving a third handwritten image, the third handwritten image generated in response to a second prompt, the second prompt comprising an object to hand draw;
fourth analyzing resulting in a fourth text output corresponding to the third handwritten image; and
generating, by analyzing a difference between the fourth text output and the object, a third handwriting skill score.

12. The computer program product of claim 11, wherein the object comprises a geometric shape.

13. The computer program product of claim 7, further comprising:
generating, by analyzing a difference between the first text output and a fifth text output corresponding to the handwritten image, a handwriting skill score, wherein the fifth text output comprises an analysis of the handwritten image produced by a human.

14. The computer program product of claim 7, further comprising:
generating, by comparing the handwriting skill score to a previous handwriting skill score, a skill trend.

15. A computer system comprising a processor and one or more computer readable storage media, and program instructions collectively stored on the one or more computer readable storage media, the program instructions executable by the processor to cause the processor to perform operations comprising:
first analyzing, using a first image-to-text model having a first performance level, a handwritten image, the first analyzing resulting in a first text output corresponding to the handwritten image;
second analyzing, using a second image-to-text model having a second performance level, the handwritten image, wherein the first performance level and the second performance level are configured using different tolerance levels for a handwriting variation, the second analyzing resulting in a second text output corresponding to the handwritten image; and
generating, by analyzing a difference between the first text output and the second text output, a handwriting skill score.

16. The computer system of claim 15, further comprising:
receiving a second handwritten image, the second handwritten image generated in response to a first prompt, the first prompt comprising a portion of text to handwrite;
third analyzing, using the first image-to-text model, the second handwritten image, the third analyzing resulting in a third text output corresponding to the second handwritten image; and
generating, by analyzing a difference between the third text output and the portion of text, a second handwriting skill score.

17. The computer system of claim 15, further comprising:
receiving a third handwritten image, the third handwritten image generated in response to a second prompt, the second prompt comprising an object to hand draw;
fourth analyzing, using the first image-to-text model, the third handwritten image, the fourth analyzing resulting in a fourth text output corresponding to the third handwritten image; and
generating, by analyzing a difference between the fourth text output and the object, a third handwriting skill score.

18. The computer system of claim 17, wherein the object comprises a geometric shape.

19. The computer system of claim 15, further comprising:
generating, by analyzing a difference between the first text output and a fifth text output corresponding to the handwritten image, a handwriting skill score, wherein the fifth text output comprises an analysis of the handwritten image produced by a human.

20. The computer system of claim 15, further comprising:
generating, by comparing the handwriting skill score to a previous handwriting skill score, a skill trend.
